(19) United States
(12) Patent Application Publication
(10) Pub. No.: US 2021/0299925 A1
(43) Pub. Date: Sep. 30, 2021

(54) INJECTION MOLDING APPARATUS AND THREE-DIMENSIONAL SHAPING APPARATUS

(71) Applicant: SEIKO EPSON CORPORATION, Tokyo (JP)

(72) Inventor: Kakeru SASAGAWA, Matsumoto-shi (JP)

(21) Appl. No.: 17/208,437

(22) Filed: Mar. 22, 2021

(30) Foreign Application Priority Data
Mar. 24, 2020 (JP) 2020-052912

(51) Int. Cl. B29C 45/47; B33Y 30/00; B29C 64/209; B29C 45/76; B28B 1/00; B28B 1/24; B22D 17/20; B22F 12/53

(52) U.S. Cl. CPC B29C 45/47; B33Y 30/00; B29C 64/209; B29C 45/76; B28B 1/001; B29C 2945/76775; B22D 17/2061; B22D 17/2023; B22F 12/53; B29C 2945/76076; B28B 1/24

(57) ABSTRACT

An injection molding apparatus includes a melting section configured to melt a solid material into a shaping material and a nozzle configured to inject the shaping material supplied from the melting section into a mold. The melting section includes a screw having a groove forming surface on which a groove is formed, a barrel having an opposed surface opposed to the groove forming surface, a communication hole communicating with the nozzle being provided in the barrel, a heating section configured to heat the solid material supplied to between the screw and the barrel, a driving motor, a first gear configured to transmit a driving force of the driving motor to the screw and rotate the screw, and a first injecting section including a first injection port for injecting a first lubricant and a first injection path leading from the first injection port to the first gear.

The present application is based on, and claims priority from JP Application Serial Number 2020-052912, filed Mar. 24, 2020, the disclosure of which is hereby incorporated by reference herein in its entirety.

### BACKGROUND

### 1. Technical Field

The present disclosure relates to an injection molding apparatus and a three-dimensional shaping apparatus.

### 2. Related Art

An apparatus including a melting section that melts a solid material into a shaping material while rotating a screw and a nozzle that injects the shaping material supplied from the melting section has been used. For example, JP-A-2010-241016 (Patent Literature 1) discloses an injection molding machine that plasticizes a molding material while rotating a rotor and injects the plasticized molding material from a nozzle. JP-A-2018-187777 (Patent Literature 2) discloses a three-dimensional shaping apparatus that plasticizes a material with a flat screw rotated by a motor to form a melted material and injects the melted material from a nozzle.

However, in the apparatus including the melting section that melts a solid material into a shaping material while rotating the screw, since a gear that transmits a driving force of a driving motor to the screw wears, it is necessary to perform a maintenance process. However, since the maintenance process takes time, it is desirable that a maintenance cycle, which is a period from execution of the maintenance process to the next execution of the maintenance process, is longer.

### SUMMARY

An injection molding apparatus according to an aspect of the present disclosure includes: a melting section configured to melt a solid material into a shaping material; and a nozzle configured to inject the shaping material supplied from the melting section into a mold. The melting section includes: a screw having a groove forming surface on which a groove is formed; a barrel having an opposed surface opposed to the groove forming surface, a communication hole communicating with the nozzle being provided in the barrel; a heating section configured to heat the solid material supplied to between the screw and the barrel; a driving motor; a first gear configured to transmit a driving force of the driving motor to the screw and rotate the screw; and a first injecting section including a first injection port for injecting a first lubricant and a first injection path leading from the first injection port to the first gear.

A three-dimensional shaping apparatus according to an aspect of the present disclosure includes: a melting section configured to melt a solid material into a shaping material; and a nozzle configured to inject the shaping material supplied from the melting section. The melting section includes: a screw having a groove forming surface on which a groove is formed; a barrel having an opposed surface opposed to the groove forming surface, a communication hole communicating with the nozzle being provided in the barrel; a heating section configured to heat the solid material supplied to between the screw and the barrel; a driving motor; a first gear configured to transmit a driving force of the driving motor to the screw and rotate the screw; and a first injecting section including a first injection port for injecting a first lubricant and a first injection path leading from the first injection port to the first gear.

### BRIEF DESCRIPTION OF THE DRAWINGS

FIG. 1 is a sectional view showing a schematic configuration of an injection molding apparatus in a first embodiment of the present disclosure.

FIG. 2 is a schematic perspective view showing the configuration of a flat screw in the injection molding apparatus in the first embodiment of the present disclosure.

FIG. 3 is a schematic diagram showing the configuration of a barrel in the injection molding apparatus in the first embodiment of the present disclosure.

FIG. 4 is a sectional view for explaining a nozzle periphery of the injection molding apparatus in the first embodiment of the present disclosure and is an enlarged view of a region in FIG. 1.

FIG. 5 is a sectional view for explaining dimensions around a gate opening of the injection molding apparatus in the first embodiment of the present disclosure.

FIG. 6 is a sectional view showing a schematic configuration of a material generating section of the injection molding apparatus in the first embodiment of the present disclosure.

FIG. 7 is a sectional view showing a schematic configuration of a first injecting section of the injection molding apparatus in the first embodiment of the present disclosure.

FIG. 8 is a schematic diagram showing a schematic configuration of the material generating section of the injection molding apparatus in the first embodiment of the present disclosure and is a diagram showing a state in which a grease nipple is detached.

FIG. 9 is a perspective view showing the grease nipple of the injection molding apparatus in the first embodiment of the present disclosure.

FIG. 10 is a perspective view showing a first gear of the injection molding apparatus in the first embodiment of the present disclosure.

FIG. 11 is a perspective view showing a schematic configuration of a second injecting section of the injection molding apparatus in the first embodiment of the present disclosure.

FIG. 12 is a sectional view showing a schematic configuration of the second injecting section of the injection molding apparatus in the first embodiment of the present disclosure.

FIG. 13 is a sectional view showing a schematic configuration of a mold opening and closing section of the injection molding apparatus in the first embodiment of the present disclosure.

FIG. 14 is a sectional view showing a schematic configuration of a third injecting section of the injection molding apparatus in the first embodiment of the present disclosure.

FIG. 15 is a sectional view showing a schematic configuration of a material generating section of an injection molding apparatus in a second embodiment of the present disclosure.

FIG. 16 is a schematic diagram showing a schematic configuration of the material generating section of the injection molding apparatus in the second embodiment of the present disclosure.

FIG. 17 is a schematic diagram of a three-dimensional shaping apparatus in a third embodiment of the present disclosure.

### DESCRIPTION OF EXEMPLARY EMBODIMENTS

First, the present disclosure is schematically explained.

An injection molding apparatus according to a first aspect of the present disclosure includes: a melting section configured to melt a solid material into a shaping material; and a nozzle configured to inject the shaping material supplied from the melting section into a mold. The melting section includes: a screw having a groove forming surface on which a groove is formed; a barrel having an opposed surface opposed to the groove forming surface, a communication hole communicating with the nozzle being provided in the barrel; a heating section configured to heat the solid material supplied to between the screw and the barrel; a driving motor; a first gear configured to transmit a driving force of the driving motor to the screw and rotate the screw; and a first injecting section including a first injection port for injecting a first lubricant and a first injection path leading from the first injection port to the first gear.

According to this aspect, the melting section includes the first injecting section including the first injection port for injecting the first lubricant and the first injection path leading from the first injection port to the first gear. Accordingly, it is possible to easily inject the first lubricant into the first gear from the outside of the apparatus via the first injection port and the first injection path. It is possible to suppress wear of the first gear by injecting the first lubricant into the first gear and extend a maintenance cycle.

According to a second aspect of the present disclosure, the injection molding apparatus according to the first aspect may further include: a first timer; and a first storing section communicating with the first injection port and storing the first lubricant, and the first injecting section may include an automatic injecting section configured to, when elapse of a predetermined time is measured by the first timer, automatically inject the first lubricant into the first injection port from the first storing section.

According to this aspect, it is possible to automatically inject the first lubricant every time the predetermined time elapses. Accordingly, it is possible to prevent wear of the first gear from being accelerated because a user forgets to inject the first lubricant.

According to a third aspect of the present disclosure, the injection molding apparatus according to the first aspect may further include: a first detecting section configured to detect injection timing based on at least one of vibration of the first gear, torque of the driving motor, and pressure in the first injection path; and a first storing section communicating with the first injection port and storing the first lubricant, and the first injecting section may include an automatic injecting section configured to, when the first detecting section detects the injection timing, automatically inject the first lubricant into the first injection port from the first storing section.

When the first gear is worn and execution of a maintenance process is necessary, vibration of the first gear, a torque rise of the driving motor, pressure fluctuation in the injection path for the first lubricant, and the like occur. However, according to this aspect, since the injection timing is detected based on at least one of the vibration of the first gear, the torque of the driving motor, and the pressure in the first injection path, it is possible to appropriately determine a time when the execution of the maintenance process is necessary concerning the first gear. It is possible to execute the maintenance process at appropriate timing.

According to a fourth aspect of the present disclosure, the injection molding apparatus according to the first aspect may include a first filter in at least one of the first injection port and the first injection path.

According to this aspect, the injection molding apparatus includes the first filter in at least one of the first injection port and the first injection path. Accordingly, it is possible to prevent the injection path for the first lubricant from being clogged by foreign matters. It is possible to appropriately cause the first lubricant to reach the first gear.

According to a fifth aspect of the present disclosure, the injection molding apparatus according to the first aspect may further include: an injection cylinder; an injection plunger configured to slide in the injection cylinder and perform measuring operation for measuring the shaping material in the injection cylinder and injecting operation for sending the shaping material to the nozzle; an injection motor; a second gear configured to transmit a driving force of the injection motor to the injection plunger and slide the injection plunger in the injection cylinder; and a second injecting section including a second injection port for injecting a second lubricant and a second injection path leading from the second injection port to the second gear.

According to this aspect, the injection molding apparatus includes the second injecting section including the second injection port for injecting the second lubricant and the second injection path leading from the second injection port to the second gear. Accordingly, it is possible to easily inject the second lubricant into the second gear from the outside of the apparatus via the second injection port and the second injection path. It is possible to suppress wear of the second gear by injecting the second lubricant into the second gear and extend the maintenance cycle not only for the first gear but also for the second gear.

According to a sixth aspect of the present disclosure, in the injection molding apparatus according to the first aspect, the mold may include a fixed mold and a movable mold that moves with respect to the fixed mold, and the injection molding apparatus may further include: a movable-mold moving section configured to move the movable mold; a mold opening and closing motor; a third gear configured to transmit a driving force of the mold opening and closing motor to the movable-mold moving section; and a third injecting section including a third injection port for injecting a third lubricant and a third injection path leading from the third injection port to the third gear.

According to this aspect, the injection molding apparatus includes the third injecting section including a third injection port for injecting the third lubricant and the third injection path leading from the third injection port to the third gear. Accordingly, it is possible to easily inject the third lubricant into the third gear from the outside of the apparatus via the third injection port and the third injection path. It is possible to suppress wear of the third gear by injecting the third lubricant into the third gear and extend the maintenance cycle not only for the first gear but also for the third gear.

A three-dimensional shaping apparatus according to a seventh aspect of the present disclosure includes: a melting section configured to melt a solid material into a shaping material; and a nozzle configured to inject the shaping material supplied from the melting section. The melting section includes: a screw having a groove forming surface on which a groove is formed; a barrel having an opposed surface opposed to the groove forming surface, a communication hole communicating with the nozzle being provided in the barrel; a heating section configured to heat the solid material supplied to between the screw and the barrel; a driving motor; a first gear configured to transmit a driving force of the driving motor to the screw and rotate the screw; and a first injecting section including a first injection port for injecting a first lubricant and a first injection path leading from the first injection port to the first gear.

According to this aspect, the melting section includes the first injecting section including the first injection port for injecting the first lubricant and the first injection path leading from the first injection port to the first gear. Accordingly, it is possible to easily inject the first lubricant into the first gear from the outside of the apparatus via the first injection port and the first injection path. It is possible to suppress wear of the first gear by injecting the first lubricant into the first gear and extend a maintenance cycle.

Embodiments of the present disclosure are explained below with reference to the accompanying drawings.

### First Embodiment

### Overall Configuration of an Injection Molding Apparatus

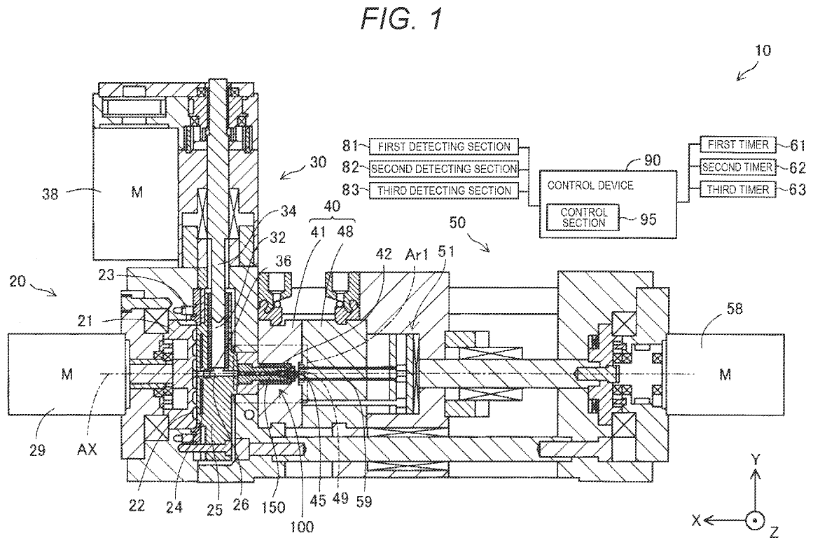

FIG. 1 is a sectional view showing a schematic configuration of an injection molding apparatus 10 in a first embodiment of the present disclosure. Since FIG. 1 is a schematic diagram, a part of constituent members are omitted, simplified, or deformed and shown. FIG. 1 schematically shows a cross section obtained by cutting the injection molding apparatus 10 along the vertical direction on a cross section including an axis AX of a channel 150 formed in a hot runner 100. In FIG. 1, an X axis, a Y axis, and a Z axis orthogonal to one another are shown. A +Z direction is equivalent to the vertical upward direction. The axis AX is parallel to the X axis. The X axis, the Y axis, and the Z axis in FIG. 1 respectively correspond to an X axis, a Y axis, and a Z axis in the other figures. The injection molding apparatus 10 injects a shaping material such as thermoplastic resin into a mold and manufactures a molded product. The injection molding apparatus 10 includes a material generating section 20, an injecting section 30, a mold for injection molding 40, a mold opening and closing section 50, and a control device 90.

The material generating section 20 generates a shaping material having fluidity by plasticizing or melting at least a part of a solid material supplied from a not-shown hopper disposed in the vertical upward direction and supplies the shaping material to the injecting section 30 side. Such a solid material is put into a hopper in various granular forms such as pellets or powder. The material generating section 20 includes a flat screw 21, a barrel 25, and a driving motor 29. The material generating section 20 includes a first gear 210 that transmits a driving force of the driving motor 29 to the flat screw 21 and a first injecting section 200 capable of injecting grease functioning as a first lubricant into the first gear 210. Details of the configuration of the first injecting section 200 are explained below.

The flat screw 21 has a substantially columnar exterior shape, the length of which along the axis AX is smaller than the diameter thereof. The flat screw 21 is disposed such that the axis AX of the channel 150 formed in the hot runner 100 and the axis AX of the flat screw 21 coincide. Grooves 22 are formed on a groove forming surface 11, which is an end face on a side opposed to the barrel 25, of the flat screw 21. Material inflow ports 23 are formed on the outer circumferential surface of the flat screw 21. The grooves 22 continue to the material inflow ports 23. The material inflow ports 23 receive the solid material supplied from the hopper.

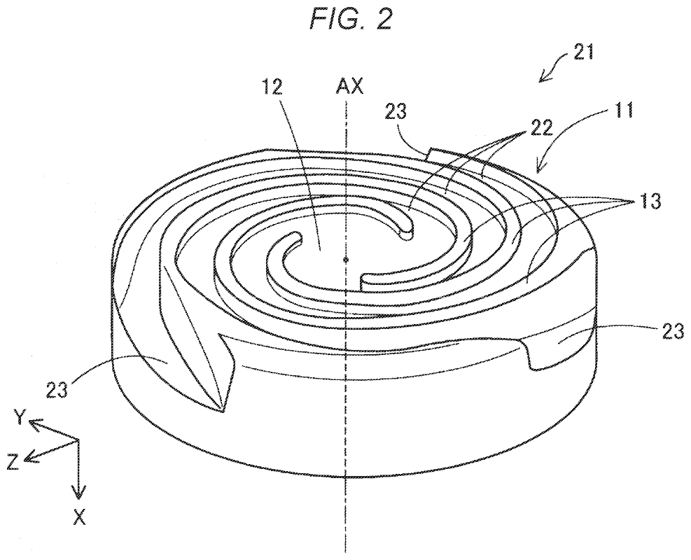

FIG. 2 is a schematic perspective view showing the configuration of the groove forming surface 11 of the flat screw 21. A center 12 of the groove forming surface 11 of the flat screw 21 is configured as a recess to which one ends of the grooves 22 are connected. The center 12 is opposed to a communication hole 26 of the barrel 25 shown in FIG. 1. In this embodiment, the center 12 crosses the axis AX. The grooves 22 of the flat screw 21 are formed by a so-called scroll groove and are formed in a swirl shape to draw arcs from the center, where the axis AX is located, toward the outer circumferential surface side of the flat screw 21. The grooves 22 may be formed in a spiral shape. Convex sections 13 forming sidewall sections of the grooves 22 and extending along the grooves 22 are provided on the groove forming surface 11.

Three grooves 22 and three convex sections 13 are formed on the groove forming surface 11 of the flat screw 21 in this embodiment. However, the number of the grooves 22 and the convex sections 13 is not limited to three and may be one or any number equal to or larger than two. Any number of the convex sections 13 may be provided according to the number of the grooves 22. Three material inflow ports 23 are formed side by side at equal intervals along the circumferential direction on the outer circumferential surface of the flat screw 21 in this embodiment. The number of the material inflow ports 23 is not limited to three and may be one or any number equal to or larger than two. Intervals of the material inflow ports 23 are not limited to the equal intervals. The material inflow ports 23 may be formed side by side at intervals different from one another.

The barrel 25 shown in FIG. 1 has a substantially disk-like exterior shape and is disposed to be opposed to the groove forming surface 11 of the flat screw 21. A heater 24 functioning as a heating section for heating a material is embedded in the barrel 25. The heater 24 may be embedded in the flat screw 21 instead of being embedded in the barrel 25. The communication hole 26 piercing through the barrel 25 along the axis AX is formed in the barrel 25. The communication hole 26 functions as a channel for guiding the shaping material to the hot runner 100. An injection cylinder 32 piercing through the barrel 25 along an axis orthogonal to the axis AX is formed in the barrel 25. The injection cylinder 32 configures a part of the injecting section 30 and communicates with the communication hole 26.

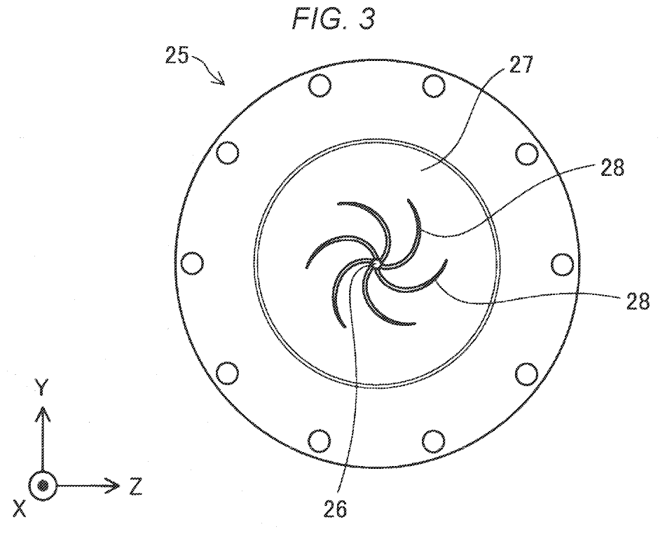

FIG. 3 is a schematic plan view showing the configuration of the barrel 25. In FIG. 3, an opposed surface 27 disposed to be opposed to the groove forming surface 11 of the flat screw 21 in the barrel 25 is shown. The communication hole 26 is formed in the center of the opposed surface 27. A plurality of guide groves 28 connected to the communication hole 26 and extending in a swirl shape toward the outer circumference from the communication hole 26 are formed on the opposed surface 27. The plurality of guide grooves 28 have a function of guiding the shaping material flowing into the center 12 of the flat screw 21 to the communication hole 26. As explained above, in this embodiment, the barrel 25 includes the plurality of guide grooves 28. However, the barrel 25 may not include the guide grooves 28.

The driving motor 29 shown in FIG. 1 is connected to an end face of the flat screw 21 on the opposite side of the side opposed to the barrel 25. The driving motor 29 is driven according to a command from a control section 95 and rotates the flat screw 21 with the axis AX as a rotation axis.

At least a part of a material supplied from the material inflow ports 23 is conveyed while being heated by a heating member of the barrel 25 in the grooves 22 of the flat screw 21 and being plasticized or melted by rotation of the flat screw 21 to be improved in fluidity and is guided to the communication hole 26. Compression and degassing of the shaping material are realized by the rotation of the flat screw 21. The “plasticized” means that a material having thermoplasticity is softened by being heated to temperature equal to or higher than a glass transition point and expresses fluidity. The “melted” means not only that the material having thermoplasticity is heated to temperature equal to or higher than a melting point to be a liquid state but also that the material having thermoplasticity is plasticized.

The injecting section 30 measures the shaping material supplied from the material generating section 20 and injects the shaping material into a cavity 49 formed in a movable mold 48 of the mold for injection molding 40. The injecting section 30 includes the injection cylinder 32, an injection plunger 34, a check valve 36, an injection motor 38, and the hot runner 100. The injecting section 30 includes a second gear 310 that transmits a driving force of the injection motor 38 to the injection plunger 34 and a second injecting section 300 capable of injecting grease functioning as a second lubricant into the second gear 310. Details of the configuration of the second injecting section 300 are explained below.

The injection cylinder 32 is formed in a substantially cylindrical shape on the inside of the barrel 25 and communicates with the communication hole 26. The injection plunger 34 is slidably disposed in the injection cylinder 32. The injection plunger 34 slides in a +Y direction, whereby the shaping material in the communication hole 26 is drawn into the injection cylinder 32 and measured. The injection plunger 34 slides in a −Y direction, whereby the shaping material in the injection cylinder 32 is pressure-fed to the hot runner 100 side and injected into the cavity 49. The check valve 36 is disposed in the communication hole 26 further on the flat screw 21 side than a communication part of the injection cylinder 32 and the communication hole 26. The check valve 36 allows a flow of the shaping material from the flat screw 21 side to the hot runner 100 side and suppresses a backflow of the shaping material from the hot runner 100 side to the flat screw 21 side. When the injection plunger 34 slides in the vertical downward direction, a spherical valve body included in the check valve 36 moves to the flat screw 21 side, whereby the communication hole 26 is closed. The injection motor 38 is driven according to a command from the control section 95 and slides the injection plunger 34 in the injection cylinder 32. Sliding speed and a sliding amount of the injection plunger 34 are set in advance according to a type of the shaping material, the size of the cavity 49, and the like. The hot runner 100 has a function of guiding the shaping material to the cavity 49 in a heated state.

The mold for injection molding 40 includes a fixed mold 41 and the movable mold 48. A hot runner attachment hole 42 piercing through the fixed mold 41 along the axis AX is formed on the inside of the fixed mold 41. The hot runner 100 is disposed in the hot runner attachment hole 42.

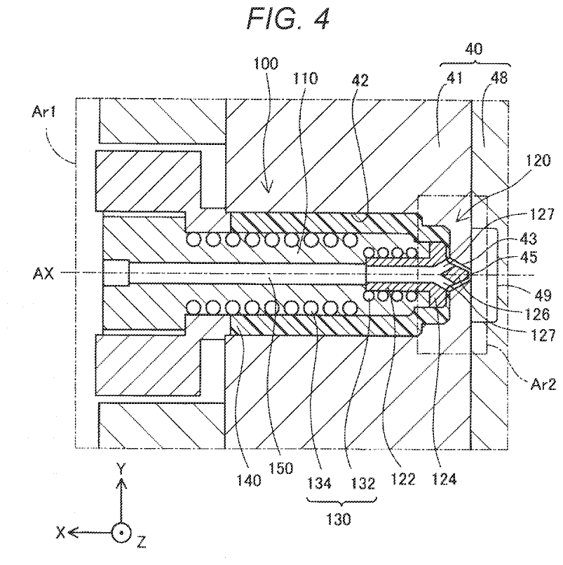

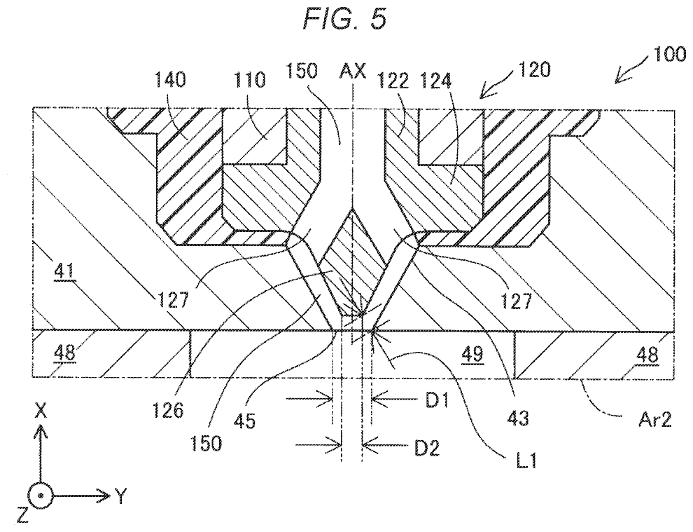

FIG. 4 is an enlarged sectional view showing a region Ar1 in FIG. 1. The hot runner attachment hole 42 is formed with the inner diameter thereof reduced stepwise in order from the material generating section 20 side. An end portion 43 of the hot runner attachment hole 42 on the opposite side of the material generating section 20 side is formed in a substantially conical shape, the inner diameter of which gradually decreases. The distal end side of the end portion 43 functions as a gate opening 45 into which the shaping material flows. The gate opening 45 is formed as a substantially circular hole. A gate 150a (see FIG. 5) near the gate opening 45 is formed in an opening gate structure of a so-called ring gate.

The movable mold 48 shown in FIGS. 1 and 4 are disposed to be opposed to the fixed mold 41. The movable mold 48 is brought into contact with the fixed mold 41 at the time of mold closing and mold clamping including an injection time and a cooling time of the shaping material and is separated from the fixed mold 41 at the time of mold opening including a release time of a molded product. The fixed mold 41 and the movable mold 48 come into contact with each other, whereby the cavity 49 communicating with the gate opening 45 is formed between the fixed mold 41 and the movable mold 48. The cavity 49 is designed in advance in a shape of a molded product molded by injection molding. In this embodiment, the cavity 49 is formed to be directly connected to the gate opening 45. However, the cavity 49 may be formed to be connected to the gate opening 45 via a runner.

In this embodiment, the mold for injection molding 40 is formed by an invar material. The invar material has a characteristic that a coefficient of thermal expansion is extremely small. A not-shown coolant channel is formed in the mold for injection molding 40. A coolant such as cooling water is fed to the coolant channel, whereby the temperature of the mold for injection molding 40 is kept lower than a melting temperature of resin and the shaping material injected into the cavity 49 is cooled and hardened. The coolant is also fed in both of the mold clamping time and the mold opening time. The cooling and the hardening of the shaping material may be realized using any cooling means such as a Peltier element instead of feeding the coolant to the coolant channel.

The mold opening and closing section 50 shown in FIG. 1 performs opening and closing of the fixed mold 41 and the movable mold 48. The mold opening and closing section 50 includes a molding opening and closing motor 58, a movable-mold moving section 51, and a pushout pin 59. The mold opening and closing motor 58 is driven according to a command from the control section 95 and moves the movable mold 48 along the axis AX. Consequently, the mold closing and the mold clamping and the mold opening of the mold for injection molding 40 are realized. The pushout pin 59 is disposed in a position communicating with the cavity 49. The pushout pin 59 pushes out a molded product in the mold opening to thereby release the molded product. The mold opening and closing section 50 includes a third gear 510 that transmits a driving force of the mold opening and closing motor 58 to the movable-mold moving section 51 and a third injecting section 500 capable of injecting grease functioning as a third lubricant into the third gear 510. Details of the configuration of the third injecting section 500 are explained below.

The control device 90 controls the operation of the entire injection molding apparatus 10 and causes the injection molding apparatus 10 to execute injection molding. The control device 90 is configured by a computer including a CPU, a storage device, and an input and output interface. The CPU executes a control program stored in the storage device in advance to thereby function as the control section 95. The control section 95 controls the temperature of a heater 130 embedded in the hot runner 100 and adjusts the temperature of the hot runner 100. A user of the injection molding apparatus 10 can perform various settings concerning injection molding conditions such as a setting temperature of the heater 130.

As shown in FIG. 1, the control device 90 is connected to a first timer 61, a second timer 62, and a third timer 63. The control device 90 is connected to a first detecting section 81, a second detecting section 83, and a third detecting section 83.

The hot runner 100 guides the shaping material supplied from the injecting section 30 to the gate opening 45 in a heated state. The hot runner 100 is disposed in the hot runner attachment hole 42 of the fixed mold 41. As shown in FIG. 4, the hot runner 100 includes a main body section 110, a nozzle 120, a heater 140, and a heat insulating section 140.

The main body section 110 has a substantially cylindrical exterior shape. A not-shown female screw is formed on the inner circumferential surface of the end portion on the gate opening 45 side in the main body section 110. The nozzle 120 is fixed and disposed at the end portion on the gate opening 45 side in the hot runner 100. The nozzle 120 includes a connecting section 122, a flange section 124, and a distal end portion 126. The connecting section 122 is located on the material generating section 20 side in the nozzle 120 and has a substantially cylindrical exterior shape. A not-shown male screw is formed on the outer circumferential surface of the connecting section 122. The nozzle 120 is fixed to the main body section 110 by screwing of the male screw and the female screw formed in the main body section 110. The flange section 124 has an outer diameter larger than the outer diameter of the connecting section 122 and is connected to the connecting section 122. The end face on the material generating section 20 side of the flange section 124 is in contact with the end face on the gate opening 45 side of the main body section 110. The distal end portion 126 is connected to the flange section 124 and has a substantially conical exterior shape projecting toward the gate opening 45 side.

A channel 150 along the axis AX is formed on the inside of the main body section 110 and the inside of the nozzle 120. The channel 150 has a function of guiding the shaping material to the gate opening 45. The channel 150 is divided in nozzle openings 127 formed at the distal end portion 126 of the nozzle 120. The nozzle openings 127 are opposed to the end portion 43 of the hot runner attachment hole 42. In this embodiment, two nozzle openings 127 disposed side by side at equal intervals in the circumferential direction are formed at the distal end portion 126. The number of the nozzle openings 127 is not limited to two and may be any number such as four. With such structure, the channel 150 is formed in a ring shape centering on the distal end portion 126 when viewed in the direction of the axis AX between the distal end portion 126 and the end portion 43. Accordingly, the gate opening 45 is configured in an open gate structure called ring gate as well. In the open gate structure, the channel 150 is not closed even during hardening of the shaping material. The gate opening 45 is always in an opened state.

In this embodiment, the main body section 110 and the nozzle 120 are formed of aluminum. Aluminum has a characteristic that a coefficient of thermal expansion is relatively large and thermal conductivity is relatively large.

The heater 130 is configured by a coil heater embedded in the main body section 110 and heats the hot runner 100. The temperature of the heater 130 is controlled by the control section 95. A melted state of the shaping material flowing in the channel 150 is maintained by such heating. The heater 130 includes a first heater 132 and a second heater 134. The first heater 132 is disposed around the nozzle 120 to surround the connecting section 122 and heats the nozzle 120. The second heater 134 is disposed further away from the nozzle 120 than the first heater 132. In this embodiment, the second heater 134 is disposed in the outer circumference portion of the main body section 110 further on the material generating section 20 side than the nozzle 120. The first heater 132 and the second heater 134 are not limited to the coil heater and may be configured by any heater such as a band heater.

FIG. 5 is a sectional view for explaining dimensions around the gate opening 45. In FIG. 5, a region Art in FIG. 4 are enlarged and schematically shown. Dimensions explained below mean dimensions at a control temperature at the time when the shaping material is injected from the hot runner 100 into the cavity 49. In this embodiment, a diameter D1 of the gate opening 45 centering on the axis AX is set to approximately 0.2 mm. A diameter D2 of the distal end portion 126 of the nozzle 120 centering on the axis AX is set to approximately 0.05 mm. A narrowest dimension L1, which is the smallest dimension among dimensions of a gap between the distal end portion 126 of the nozzle 120 and the gate opening 45, is set to approximately 0.05 mm. In this embodiment, the gap between the distal end portion 126 of the nozzle 120 and the gate opening 45 means a gap between the distal end portion 126 of the nozzle 120 and the edge of the gate opening 45 formed in the fixed mold 41.

### Shaping Material

Materials used in the injection molding apparatus 10 are explained. In the injection molding apparatus 10, injection molding can be performed using, as a main material, various materials such as a material having thermoplasticity, a metal material, and a ceramic material. The “main material” means a material mainly forming the shape of a molded product and means a material having an occupancy ratio equal to or higher than 50 weight % in the molded product. The shaping material includes the main material melted alone or a material obtained by melting a part of components contained together with the main material into a paste shape.

When the material having thermoplasticity is used as the main material, the material generating section 20 generates the shaping material by plasticizing the material. The “plasticizing” means applying heat to the material having thermoplasticity and melting the material.

As the material having thermoplasticity, for example, a thermoplastic resin material obtained by combining one kind or two or more kinds selected out of the following can be used. Examples of the thermoplastic resin material include general-purpose engineering plastic such as polypropylene resin (PP), polyethylene resin (PE), polyacetal resin (POM), polyvinylchloride resin (PVC), polyamide resin (PA), acrylonitrile butadiene styrene resin (ABS), polylactic rein (PLA), polyphenylene sulfide resin (PPS), polyether ether ketone (PEEK), polycarbonate (PC), denaturated polyphenylene ether, polybutylene terephthalate, and polyethylene terephthalate and engineering plastic such as polysulphone, polyether sulphone, polyphenylene sulfide, polyarylate, polyimide, polyamide imide, polyether imide, and polyether ether ketone.

Pigment, metal, ceramic, or the like may be mixed in the material having thermoplasticity. For example, an additive such as wax, a flame retardant, an antioxidant, or a heat stabilizer may be mixed in the material having thermoplasticity. Fiber such as carbon fiber, glass fiber, cellulose fiber, or aramid fiber may be mixed in the material having thermoplasticity.

It is desirable that the material having thermoplasticity is injected from the nozzle 120 of the hot runner 100 in a state in which the material having thermoplasticity is heated to temperature equal to or higher than the glass transition point and completely melted. For example, ABS resin, the glass transition point of which is approximately 120° C., may be injected at approximately 200° C. set as a first temperature explained below.

In the injection molding apparatus 10, for example, a metal material may be used as the main material instead of the material having thermoplasticity. In this case, it is desirable that a component to be melted in the generation of the shaping material is mixed in a power material obtained by powdering the metal material described below and is supplied to the material generating section 20. Examples of the metal material include single material such as magnesium (Mg), iron (Fe), cobalt (Co), chrome (Cr), aluminum (Al), titanium (Ti), copper (Cu), and nickel (Ni) and an alloy including one or more of these kinds of metal. Examples of the alloy include maraging steel, stainless steel, cobalt chrome molybdenum, a titanium alloy, a nickel alloy, an aluminum alloy, a cobalt alloy, and a cobalt chrome alloy.

In the injection molding apparatus 10, it is possible to use a ceramic material as the main material instead of the metal material. As the ceramic material, for example, oxide ceramics such as silicon dioxide, titanium dioxide, aluminum oxide, and zirconium oxide and non-oxide ceramics such as aluminum nitride can be used.

The powder material of the metal material or the ceramic material supplied to the material generating section 20 may be a mixed material obtained by mixing a plurality of kinds of powder of the single metal, powder of the alloy, and powder of the ceramic material. The powder material of the metal material or the ceramic material may be coated by, for example, the thermoplastic resin illustrated above or thermoplastic resin other than the thermoplastic resin. In this case, in the material generating section 20, the thermoplastic resin may be melted to express fluidity.

For example, a solvent can also be added to the powder material of the metal material or the ceramic material supplied to the material generating section 20. As the solvent, one or two or more kinds selected out of the following can be used in combination. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; ester acetates such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, di-isopropyl ketone, and acetyl acetone; alcohols such as ethanol, propanol, and butanol; tetra alkyl ammonium acetates; sulfoxide-based solvents such as dimethyl sulfoxide and diethyl sulfoxide; pyridine-based solvents such as pyridine, γ-picoline, and 2,6-lutidine; tetra alkyl ammonium acetate (for example, tetra butyl ammonium acetate); and ion liquid such as butyl carbitol acetate.

Besides, for example, a binder can also be added to the powder material of the metal material or the ceramic material supplied to the material generating section 20. Examples of the binder include acryl resin, epoxy resin, silicone resin, cellulose-based resin and other synthetic resin and PLA (polylactic acid), PA (polyamide), PPS (polyphenylene sulfide), PEEK (polyether ether ketone), and other thermoplastic resin.

### First Injecting Section

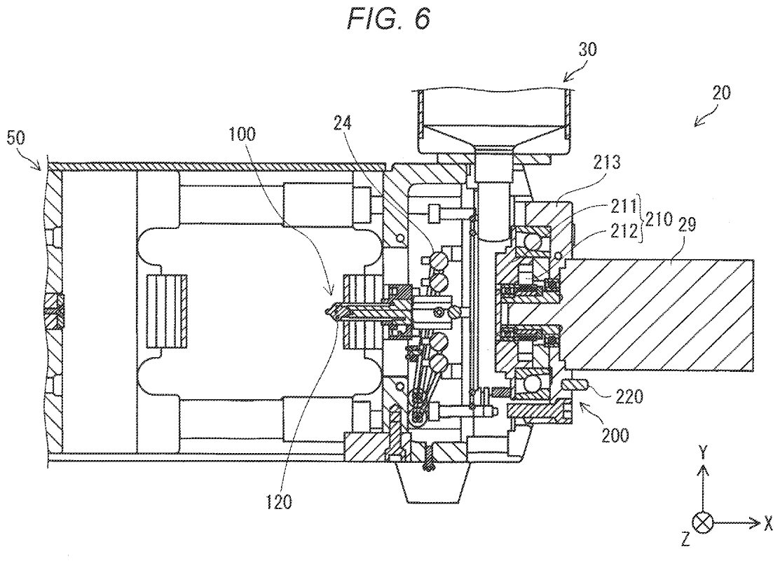

As explained above, the injection molding apparatus 10 in this embodiment includes the material generating section 20 including the first gear 210 that transmits a driving force of the driving motor 29 to the flat screw 21 and the first injecting section 200 capable of injecting grease functioning as an example of the first lubricant into the first gear 210. The injection molding apparatus 10 in this embodiment is capable of using the grease as the first lubricant. However, the first lubricant is not limited to the grease. A liquid-like lubricant having viscosity lower than the viscosity of the grease, a powder-like lubricant, or the like may be used. The first injecting section 200 is explained below with reference to FIGS. 6 to 10.

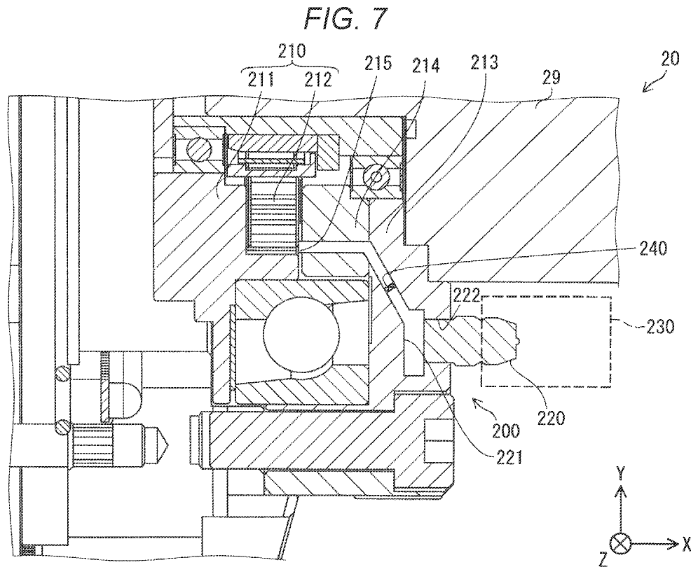

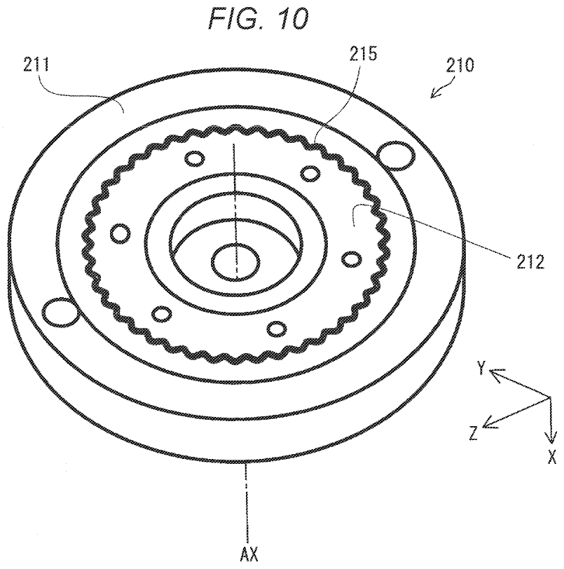

As shown in FIGS. 6 to 8, the material generating section 20 includes a base section 213 to which the driving motor 29 and the like are attached and the first gear 210 that transmits a driving force of the driving motor 29 to the flat screw 21 and rotates the flat screw 21. As shown in FIG. 7, an intermediate member 214 is provided between the base section 213 and the first gear 210. The first gear 210 has a configuration shown in FIG. 10 and includes a sun gear 211 on the outer side and a planetary gear 212 on the inner side having the axis AX as a common rotation axis.

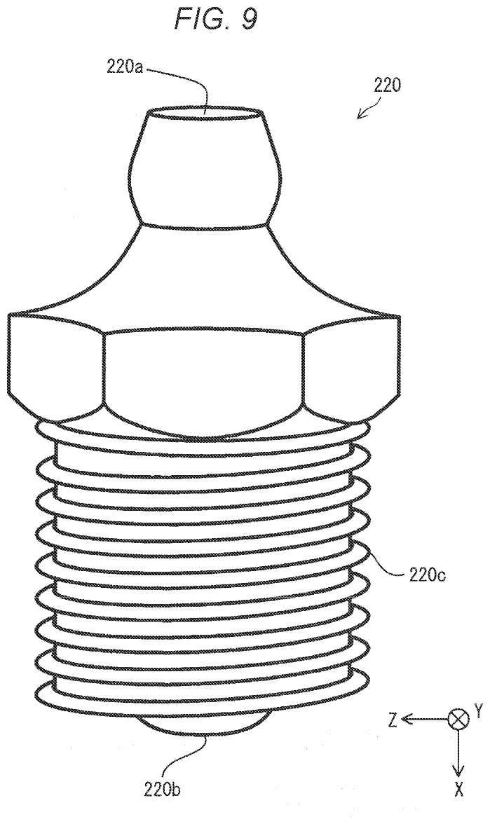

As shown in FIGS. 6 to 8, a grease nipple 220 is attached to the base section 213. The grease nipple 220 has a configuration shown in FIG. 9. A through-hole piercing through the grease nipple 220 from one end 220a to the other end 220b is provided. The grease nipple 220 is configured to be capable of feeding the grease from one end 220a to the other end 220b. A not-shown check valve is provided in the through-hole. The grease nipple 220 prevents the grease from flowing back from the other end 220b to one end 220a. As shown in FIG. 9, the grease nipple 220 includes a male screw section 220c. As shown in FIG. 7, the grease nipple 220 is fit in a first injection port 222, which is a female screw section, provided in the base section 213.

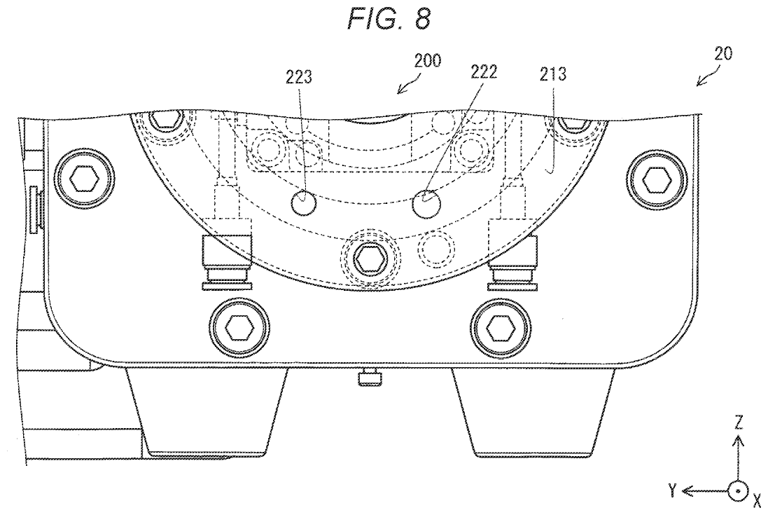

As shown in FIG. 7, in the first injecting section 200, a first injection path 221 leading from the first injection port 222 to a position opposed to a region 215 between the sun gear 211 and the planetary gear 212 is formed. The first injection path 221 is configured by opening holes in the base section 213 and the intermediate member 214. Since the first injecting section 200 has such a configuration, the first injecting section 200 can inject the grease into the first gear 210 via the through-hole of the grease nipple 220, the first injection port 222, and the first injection path 221. As shown in FIG. 8, a discharge port 223 is formed in the base section 213. Unnecessary grease of the grease injected into the first gear 210 can be discharged from the discharge port 223. The unnecessary grease is discharged from the discharge port 223 via, for example, gaps of constituent members such as a gap between the first gear 210 and the intermediate member 214 and a gap between the intermediate member 214 and the base section 213. Old grease can be replaced with new grease by discharging the grease from the discharge port 223 while injecting the grease into the first gear 210 from the first injection port 222.

In the injection molding apparatus 10 in this embodiment, the user can inject the grease into the first gear 210 by injecting, with a syringe or the like, the grease from one end 220a of the grease nipple 220. As explained in detail below, in the injection molding apparatus 10 in this embodiment, the grease can also be automatically injected into the first gear 210 by attaching a first storing section 230 storing the grease to one end 220a of the grease nipple 220 as indicated by a broken line in FIG. 7.

Summarizing the above explanation, the injection molding apparatus 10 in this embodiment includes the material generating section 20 functioning as the melting section that melts a solid material into a shaping material and the nozzle 120 that injects the shaping material supplied from the material generating section 20 into the mold. The material generating section 20 includes the flat screw 21 having the groove forming surface 11 on which the grooves 22, to which the solid material is supplied, are formed, the barrel 25 having the opposed surface 27 opposed to the groove forming surface 11, the communication hole 26 communicating with the nozzle 120 being provided on the opposed surface, the heater 24 that heats the solid material supplied to the grooves 22, that is, between the flat screw 21 and the barrel 25, the driving motor 29, and the first gear 210 that transmits a driving force of the driving motor 29 to the flat screw 21 and rotates the flat screw 21. Further, as explained above, the material generating section 20 includes the first injecting section 200 including the first injection port 222 for injecting the grease and the first injection path 221 leading from the first injection port 222 to the first gear 210.

In this way, the material generating section 20 includes the first injecting section 200 including the first injection port 222 for injecting the grease and the first injection path 221 leading from the first injection port 222 to the first gear 210. Therefore, it is possible to easily inject the grease into the first gear 210 from the outside of the injection molding apparatus 10 via the first injection port 222 and the first injection path 221. Accordingly, the injection molding apparatus 10 in this embodiment can suppress wear of the first gear 210 by injecting the grease into the first gear 210 and extend the maintenance cycle.

As explained above, the injection molding apparatus 10 in this embodiment includes the first timer 61. The first storing section 230 communicating with the first injection port 222 and storing the grease can be attached to the injection molding apparatus 10. According to the control by the control section 95, when the elapse of the predetermined time is measured by the first timer 61, the first injecting section 200 can automatically inject the grease into the first injection port 222 from the first storing section 230. That is, the injection molding apparatus 10 in this embodiment includes an automatic injecting section including the control section 95, the first timer 61, and the first injecting section 200 and can automatically inject the grease every time the predetermined time elapsed. Accordingly, the injection molding apparatus 10 in this embodiment can prevent wear of the first gear 210 from being accelerated because the user forgets to inject the grease.

As explained above, the injection molding apparatus 10 in this embodiment includes the first detecting section 81. The first detecting section 81 can detect injection timing of the grease based on at least one of vibration of the first gear 210, torque of the driving motor 29, and pressure in the first injection path 221. As explained above, the first storing section 230 communicating with the first injection port 222 and storing the grease can be attached to the injection molding apparatus 10 in this embodiment. When the first detecting section 81 detects the injection timing, the first injecting section 200 can automatically inject the grease into the first injection port 222 from the first storing section 230. When the first gear 210 is worn and execution of a maintenance process is necessary, vibration of the first gear 210, a torque rise of the driving motor 29, pressure fluctuation in the first injection path 221, which is an injection path for the grease, and the like occur. However, the injection molding apparatus 10 in this embodiment includes the automatic injecting section including the control section 95, the first detecting section 81, and the first injecting section 200 and detects the injection timing based on at least one of the vibration of the first gear 210, the torque of the driving motor 29, and the pressure in the first injection path 221. Therefore, it is possible to appropriately determine time when the execution of the maintenance process is necessary concerning the first gear 210 and execute the maintenance process at appropriate timing.

As shown in FIG. 7, the injection molding apparatus 10 in this embodiment includes a first filter 240 in the first injection path 221. In this way, it is preferable to provide the first filter 240 in at least one of the first injection port 222 and the first injection path 221. This is because it is possible to prevent the injection path for the grease from being clogged by foreign matters and appropriately cause the grease to reach the first gear 210.

### Second Injecting Section

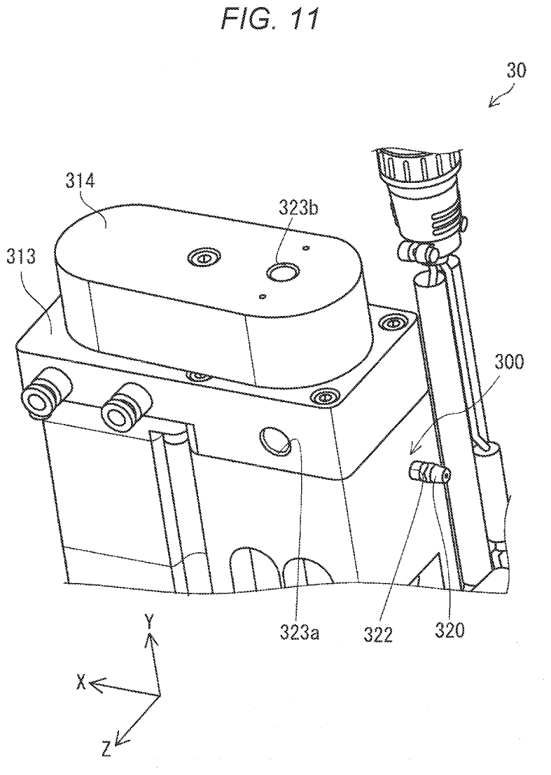

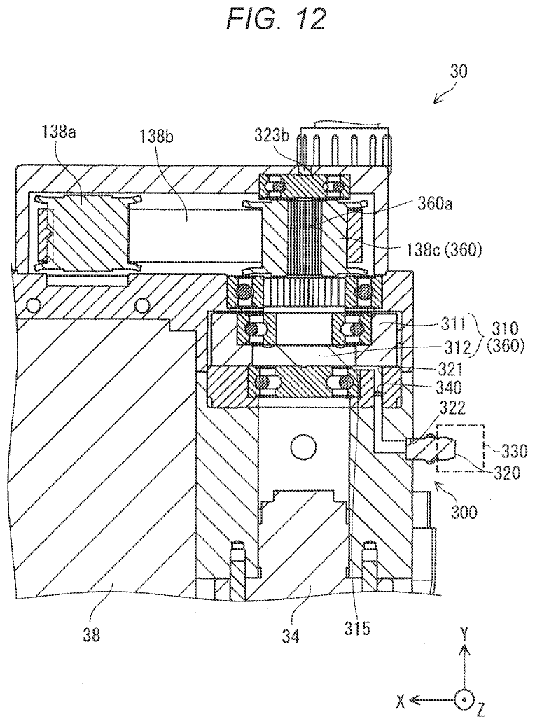

As explained above, the injection molding apparatus 10 in this embodiment includes the injecting section 30 that measures the shaping material supplied from the material generating section 20 and injects the shaping material into the cavity 49 formed in the movable mold 48 of the mold for injection molding 40. The injecting section 30 includes the injection cylinder 32, the injection plunger 34, and the injection motor 38. The injection plunger 34 slides in the injection cylinder 32 and performs measuring operation for measuring the shaping material in the injection cylinder 32 and injecting operation for feeding the shaping material to the nozzle. The injecting section 30 includes the second injecting section 300. The second injecting section 300 is explained below with reference to FIGS. 11 and 12.

As shown in FIG. 12, the injecting section 30 includes the second gear 310 that transmits a driving force of the injection motor 38 to the injection plunger 34 via a rotating section 138a, a belt 138b, a rotating section 138c, and the like and slides the injection plunger 34 in the injection cylinder 32. The injecting section 30 includes the second injecting section 300 including a second injection port 322 for injecting grease functioning as an example of a second lubricant, a second injection path 321 leading from the second injection port 322 to the second gear 310, and a grease nipple 320 attached to the second injection port 322. The grease nipple 320 has the same configuration as the configuration of the grease nipple 220. The second gear 310 has the same configuration as the configuration of the first gear 210.

In this way, the injection molding apparatus 10 in this embodiment includes the second injecting section 300 including the second injection port 322 for injecting the grease and the second injection path 321 leading from the second injection port 322 to the second gear 310. Accordingly, it is possible to easily inject the grease into the second gear 310 from the outside of the injection molding apparatus 10 via the second injection port 322 and the second injection path 321. It is possible to suppress wear of the second gear 310 by injecting the grease into the second gear 310. It is possible to extend a maintenance cycle not only for the first gear 210 but also for the second gear 310.

As explained above, the injection molding apparatus 10 in this embodiment includes the second timer 62. Since the grease nipple 320 has the same configuration as the configuration of the grease nipple 220, a second storing section 330 communicating with the second injection port 322 and storing the grease can be attached to the grease nipple 320. According to the control by the control section 95, when elapse of a predetermined time is measured by the second timer 62, the second injecting section 300 can automatically inject the grease into the second injection port 322 from the second storing section 330. That is, the injection molding apparatus 10 in this embodiment includes an automatic injecting section including the control section 95, the second timer 62, and the second injecting section 300 and can automatically inject the grease every time the predetermined time elapses. Accordingly, the injection molding apparatus 10 in this embodiment can prevent wear of the second gear 310 from being accelerated because the user forgets to inject the grease. Since the second gear 310 has the same configuration as the configuration of the first gear 210, the second gear 310 includes a sun gear 311 on the outer side and a planetary gear 312 on the inner side. The grease is injected into a region 315 between the sun gear 311 and the planetary gear 312 on the inner side.

As explained above, the injection molding apparatus 10 in this embodiment includes the second detecting section 82. The second detecting section 82 can detect injection timing of the grease based on at least one of vibration of the second gear 310, torque of the injection motor 38, and pressure in the second injection path 321. As explained above, the second storing section 330 communicating with the second injection port 322 and storing the grease can be attached to the injection molding apparatus 10 in this embodiment. When the second detecting section 82 detects the injection timing, the second injecting section 300 can automatically inject the grease into the second injection port 322 from the second storing section 330. When the second gear 310 is worn and execution of a maintenance process is necessary, vibration of the second gear 310, a torque rise of the injection motor 38, pressure fluctuation in the second injection path 321, which is an injection path for the grease, and the like occur. However, the injection molding apparatus 10 in this embodiment includes the automatic injecting section including the control section 95, the second detecting section 82, and the second injecting section 300 and detects the injection timing based on at least one of the vibration of the second gear 310, the torque of the injection motor 38, and the pressure in the second injection path 321. Therefore, it is possible to appropriately determine time when the execution of the maintenance process is necessary concerning the second gear 310 and execute the maintenance process at appropriate timing.

As shown in FIG. 12, the injection molding apparatus 10 in this embodiment includes a second filter 340 in the second injection path 321. In this way, it is preferable to provide the second filter 340 in at least one of the second injection port 322 and the second injection path 321. This is because it is possible to prevent the injection path for the grease from being clogged by foreign matters and appropriately cause the grease to reach the second gear 310.

As shown in FIG. 11, a discharge port 323a is formed in a base section 313. Unnecessary grease of the grease injected into the second gear 310 can be discharged from the discharge port 323a. A discharge port 323b is formed in an upper cover section 314. A rotation axis center section 360a of a rotating body 360 formed by the rotating section 138c, the second gear 310, and the like is formed as a hollow and reaches the discharge port 323b on an extended line in the Y-axis direction (a rotation axis direction of the rotating body 360) of the hollow. Accordingly, the unnecessary grease of the grease injected into the second gear 310 can be efficiently discharged from the discharge port 323b as well. Old grease can be replaced with new grease by discharging the grease from the discharge port 323a and the discharge port 323b while injecting the grease into the second gear 310 from the second injection port 322.

### Third Injecting Section

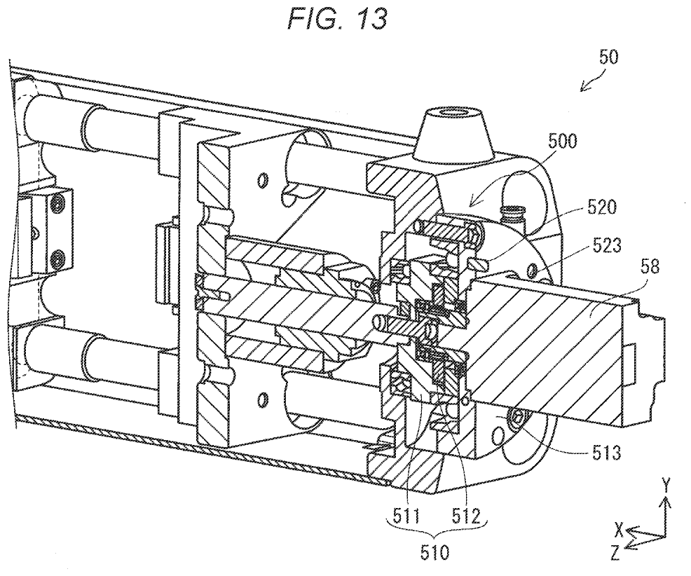

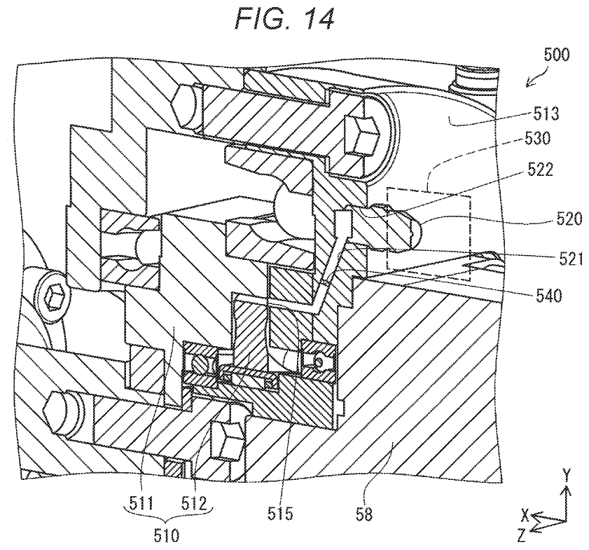

As explained above, the injection molding apparatus 10 in this embodiment includes the fixed mold 41, the movable mold 48 that moves with respect to the fixed mold 41, the movable-mold moving section 51 that moves the movable mold 48 with respect to the fixed mold 41, the mold opening and closing motor 58, and the mold opening and closing section 50 that transmits a driving force of the mold opening and closing motor 58 to the movable-mold moving section 51 and opens and closes the fixed mold 41 and the movable mold 48. The mold opening and closing section 50 includes the third injecting section 500. The third injecting section 500 is explained below with reference to FIGS. 13 and 14.

The mold opening and closing section 50 includes the third gear 510 that transmits a driving force of the mold opening and closing motor 58 to the movable-mold moving section 51. The mold opening and closing section 50 includes the third injecting section 500 including a third injection port 522 for injecting grease functioning as an example of a third lubricant, a third injection path 521 leading from the third injection port 522 to the third gear 510, and a grease nipple 520 attached to the third injection port 522. The grease nipple 520 has the same configuration as the configuration of the grease nipple 220 and the grease nipple 320. The third gear 510 has the same configuration as the configuration of the first gear 210 and the second gear 310. In this embodiment, all of the first lubricant, the second lubricant, and the third lubricant are the same grease. However, different lubricants may be used as the first lubricant, the second lubricant, and the third lubricant.

In this way, the injection molding apparatus 10 in this embodiment includes the third injecting section 500 including the third injection port 522 for injecting the grease and the third injection path 521 leading from the third injection port 522 to the third gear 510. Accordingly, it is possible to easily inject the grease into the third gear 510 from the outside of the injection molding apparatus 10 via the third injection port 522 and the third injection path 521. It is possible to suppress wear of the third gear 510 by injecting the grease into the third gear 510 and extend the maintenance cycle not only for the first gear 210 but also for the third gear 510.

As explained above, the injection molding apparatus 10 in this embodiment includes the third timer 63. Since the grease nipple 520 has the same configuration as the configuration of the grease nipple 220, a third storing section 530 communicating with the third injection port 522 and storing the grease can be attached to the grease nipple 520. According to the control by the control section 95, when elapse of a predetermined time is measured by the third timer 63, the third injecting section 500 can automatically inject the grease into the third injection port 522 from the third storing section 530. That is, the injection molding apparatus 10 in this embodiment includes an automatic injecting section including the control section 95, the third timer 63, and the third injecting section 500 and can automatically inject the grease every time the predetermined time elapses. Accordingly, the injection molding apparatus 10 in this embodiment can prevent wear of the second gear 310 from being accelerated because the user forgets to inject the grease. In the injection molding apparatus 10 in this embodiment, the injection timing of the grease is set to be shorter in the order of the first injecting section 200, the second injecting section 300, and the third injecting section 500. In other words, in the injection molding apparatus 10 in this embodiment, the injection timing of the grease is set shorter in a gear to which heat is more easily applied. Since the third gear 510 has the same configuration as the configuration of the first gear 210, the third gear 510 includes a sun gear 511 on the outer side and a planetary gear 512 on the inner side. The grease is injected into a region 515 between the sun gear 511 and the planetary gear 512 on the inner side.

As explained above, the injection molding apparatus 10 in this embodiment includes the third detecting section 83. The third detecting section 83 can detect injection timing of the grease based on at least one of vibration of the third gear 510, torque of the mold opening and closing motor 58, and pressure in the third injection path 521. As explained above, the third storing section 530 communicating with the third injection port 522 and storing the grease can be attached to the injection molding apparatus 10 in this embodiment. When the third detecting section 83 detects the injection timing, the third injecting section 500 can automatically inject the grease into the third injection port 522 from the third storing section 530. When the third gear 510 is worn and execution of a maintenance process is necessary, vibration of the third gear 510, a torque rise of the mold opening and closing motor 58, pressure fluctuation in the third injection path 521, which is an injection path for the grease, and the like occur. However, the injection molding apparatus 10 in this embodiment includes the automatic injecting section including the control section 95, the third detecting section 83, and the third injecting section 500 and detects the injection timing based on at least one of the vibration of the third gear 510, the torque of the mold opening and closing motor 58, and the pressure in the third injection path 521. Therefore, it is possible to appropriately determine time when the execution of the maintenance process is necessary concerning the third gear 510 and execute the maintenance process at appropriate timing.

As shown in FIG. 14, the injection molding apparatus 10 in this embodiment includes a third filter 540 in the third injection path 521. In this way, it is preferable to provide the third filter 540 in at least one of the third injection port 522 and the third injection path 521. This is because it is possible to prevent the injection path for the grease from being clogged by foreign matters and appropriately cause the grease to reach the third gear 510.

As shown in FIG. 13, a discharge port 523 is formed in a base section 513. Unnecessary grease of the grease injected into the third gear 510 can be discharged from the discharge port 523. Old grease can be replaced with new grease by discharging the grease from the discharge port 523 while injecting the grease into the third gear 510 from the third injection port 522.

### Second Embodiment

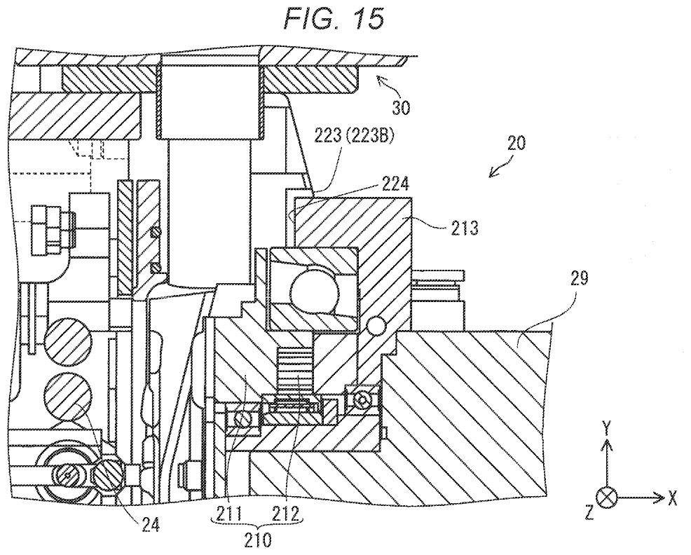

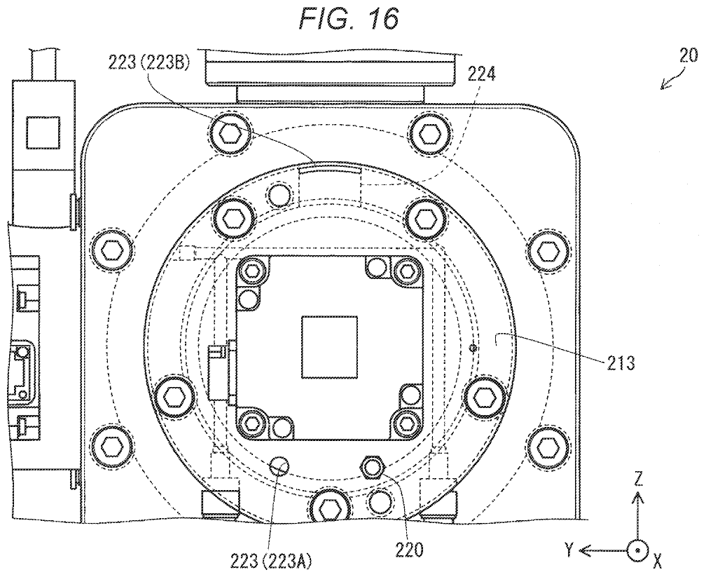

The injection molding apparatus 10 in a second embodiment is explained with reference to FIGS. 15 and 16. In FIGS. 15 and 16, constituent members common to the first embodiment are denoted by the same reference numerals and signs and detailed explanation of the constituent members is omitted. The injection molding apparatus 10 in this embodiment has the same configuration as the injection molding apparatus 10 in the first embodiment except the configuration of the material generating section 20.

As shown in FIGS. 15 and 16, in the material generating section 20 of the injection molding apparatus 10 in this embodiment, as in the material generating section 20 of the injection molding apparatus 10 in the first embodiment, the discharge port 223 is formed in the base section 213. However, the material generating section 20 includes a discharge port 223B communicating with a discharge path 224 in addition to a discharge port 223A having the same configuration as the configuration of the discharge port 223 in the injection molding apparatus 10 in the first embodiment. Since the injection molding apparatus 10 in this embodiment includes the discharge port 223B communicating with the discharge path 224, the injection molding apparatus 10 more effectively prevents grease from excessively accumulating on the inside of the injection molding apparatus 10. Accordingly, the grease does not excessively accumulate on the inside of the injection molding apparatus 10. The injection molding apparatus 10 can reduce execution frequency of a maintenance process for removing the grease on the inside of the injection molding apparatus 10.

### Third Embodiment

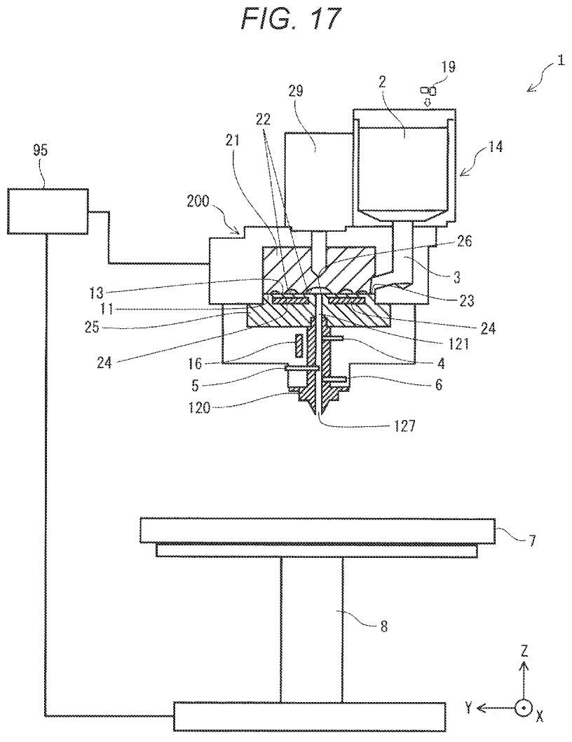

A three-dimensional shaping apparatus 1 in a third embodiment is explained with reference to FIG. 17. The three-dimensional shaping apparatus 1 in this embodiment includes a plurality of constituent members that are the same as the material generating section 20 of the injection molding apparatus 10 in the first and second embodiments. Accordingly, in FIG. 17, constituent members common to the first and second embodiments are denoted by the same reference numerals and signs and detailed explanation of the constituent members is omitted.

As shown in FIG. 17, the three-dimensional shaping apparatus 1 in this embodiment includes a plasticizing section 14 functioning as a melting section. The plasticizing section 14 includes a hopper 2 that stores pellets 19, which are an example of a solid material configuring a three-dimensional shaped object. The pellets 19 stored in the hopper 2 are supplied to the material inflow ports 23 of the substantially columnar flat screw 21 rotating with the Z-axis direction as a rotation axis with a driving force of the driving motor 29.

The flat screw 21 and the barrel 25 have the same configurations as the configurations of the flat screw 21 and the barrel 25 of the injection molding apparatus 10 in the first embodiment. Since the flat screw 21 and the barrel 25 have such configurations, by rotating the flat screw 21, the pellets 19 are supplied to a space portion formed between the groove forming surface 11 of the flat screw 21 and the opposed surface 27 of the barrel 25. The pellets 19 move from the material inflow ports 23 to the center of the space portion. When the pellets 19 move in the space portion formed by the grooves 22, the pellets 19 are melted by the heat of the heater 24. The pellets 19 are pressurized by pressure involved in the movement in the narrow space portion. In this way, the pellets 19 are plasticized, supplied to the nozzle 120 via the communication hole 26, and injected from the nozzle openings 127.

A heater 16 that heats the shaping material flowing in a channel 121 of the nozzle 120, a pressure measuring section 4 that measures the internal pressure of the channel 121, a flow-rate adjusting mechanism 5 for the shaping material flowing in the channel 121, and a purging section 6 that releases the internal pressure of the channel 121 are provided around the nozzle 120. The three-dimensional shaping apparatus 1 in this embodiment includes the first injecting section 200 having the same configuration as the configuration of the first injecting section 200 of the injection molding apparatus 10 in the first embodiment, although detailed explanation of the first injecting section 200 is omitted because the configuration of the first injecting section 200 is the same as the configuration of the first injecting section 200 of the injection molding apparatus 10 in the first embodiment.

The three-dimensional shaping apparatus 1 includes the plasticizing section 14 and the nozzle 120 as explained above and is capable of moving the plasticizing section 14, the nozzle 120, and the like along the X-axis direction and the Y-axis direction as a discharging unit. The discharging unit moves along the X-axis direction and the Y-axis direction according to the control by the control section 95. As shown in FIG. 17, in the three-dimensional shaping apparatus 1, a table 7 for shaping a three-dimensional shaped object is provided in a position opposed to the nozzle openings 127. The table 7 is movable along the Z-axis direction along the moving mechanism 8 according to the control by the control section 95.

As explained above, the three-dimensional shaping apparatus 1 in this embodiment includes the plurality of constituent members that are the same as the material generating section 20 of the injection molding apparatus 10 in the first embodiment. That is, the three-dimensional shaping apparatus 1 in this embodiment includes the plasticizing section 14 functioning as a melting section that melts the pellets 19, which are a solid material, into a shaping material and the nozzle 120 that injects the shaping material supplied from the plasticizing section 14. The plasticizing section 14 includes the flat screw 21 having the groove forming surface 11 on which the grooves 22 are formed and the barrel 25 having the opposed surface 27 opposed to the groove forming surface 11, the communication hole 26 communicating with the nozzle 120 being provided in the barrel 25. Further, the plasticizing section 14 includes the heater 24 functioning as a heating section configured to heat the pellets 19 supplied to between the flat screw 21 and the barrel 25 and the driving motor 29. Although details are omitted in FIG. 17, like the material generating section 20 of the injection molding apparatus 10 in the first embodiment, the plasticizing section 14 includes the first gear 210 that transmits a driving force of the driving motor 29 to the flat screw 21 and rotates the flat screw 21 and the first injecting section 200 including the first injection port 222 for injecting grease functioning as the first lubricant and the first injection path 221 leading from the first injection port 222 to the first gear 210. Therefore, the three-dimensional shaping apparatus 1 in this embodiment can easily inject the grease to the first gear 210 from the outside via the first injection port 222 and the first injection path 221. Accordingly, it is possible to suppress wear of the first gear 210 by injecting the grease into the first gear 210 and extend a maintenance cycle.

The present disclosure is not limited to the embodiments explained above and can be realized in various configurations without departing from the gist of the present disclosure. The technical features in the embodiments corresponding to the technical features in the aspects described in the summary can be substituted or combined as appropriate in order to solve a part or all of the problems described above or achieve a part or all of the effects described above. Unless the technical features are explained as essential technical features in this specification, the technical features can be deleted as appropriate.

What is claimed is:

1. An injection molding apparatus comprising:
a melting section configured to melt a solid material into a shaping material; and
a nozzle configured to inject the shaping material supplied from the melting section into a mold, wherein
the melting section includes:
a screw having a groove forming surface on which a groove is formed;
a barrel having an opposed surface opposed to the groove forming surface, a communication hole communicating with the nozzle being provided in the barrel;
a heating section configured to heat the solid material supplied to between the screw and the barrel;
a driving motor;
a first gear configured to transmit a driving force of the driving motor to the screw and rotate the screw; and
a first injecting section including a first injection port for injecting a first lubricant and a first injection path leading from the first injection port to the first gear.

2. The injection molding apparatus according to claim 1, further comprising:
a first timer; and
a first storing section communicating with the first injection port and storing the first lubricant, wherein
the first injecting section includes an automatic injecting section configured to, when elapse of a predetermined time is measured by the first timer, automatically inject the first lubricant into the first injection port from the first storing section.

3. The injection molding apparatus according to claim 1, further comprising:
a first detecting section configured to detect injection timing based on at least one of vibration of the first gear, torque of the driving motor, and pressure in the first injection path; and
a first storing section communicating with the first injection port and storing the first lubricant, wherein
the first injecting section includes an automatic injecting section configured to, when the first detecting section detects the injection timing, automatically inject the first lubricant into the first injection port from the first storing section.

4. The injection molding apparatus according to claim 1, wherein the injection molding apparatus includes a first filter in at least one of the first injection port and the first injection path.

5. The injection molding apparatus according to claim 1, further comprising:
an injection cylinder;
an injection plunger configured to slide in the injection cylinder and perform measuring operation for measuring the shaping material in the injection cylinder and injecting operation for sending the shaping material to the nozzle;
an injection motor;
a second gear configured to transmit a driving force of the injection motor to the injection plunger and slide the injection plunger in the injection cylinder; and
a second injecting section including a second injection port for injecting a second lubricant and a second injection path leading from the second injection port to the second gear.

6. The injection molding apparatus according to claim 1, wherein
the mold includes a fixed mold and a movable mold that moves with respect to the fixed mold, and
the injection molding apparatus further comprises:
a movable-mold moving section configured to move the movable mold;
a mold opening and closing motor;
a third gear configured to transmit a driving force of the mold opening and closing motor to the movable-mold moving section; and
a third injecting section including a third injection port for injecting a third lubricant and a third injection path leading from the third injection port to the third gear.

7. A three-dimensional shaping apparatus comprising:
a melting section configured to melt a solid material into a shaping material; and
a nozzle configured to inject the shaping material supplied from the melting section toward a stage, wherein
the melting section includes:
a screw having a groove forming surface on which a groove is formed;
a barrel having an opposed surface opposed to the groove forming surface, and a communication hole communicating with the nozzle being provided in the barrel;
a heating section configured to heat the solid material supplied to between the screw and the barrel;
a driving motor;
a first gear configured to transmit a driving force of the driving motor to the screw and rotate the screw; and
a first injecting section including a first injection port for injecting a first lubricant and a first injection path leading from the first injection port to the first gear.
